(19) United States
(12) Patent Application Publication
(10) Pub. No.: US 2007/0123409 A1
(43) Pub. Date: May 31, 2007

(54) Current stabilizing device using quartz ball

(76) Inventor: Kun-Jou Hsieh, Kaohsiung City (TW)

Correspondence Address: LEONG C LEI, PMB # 1008, 1867 YGNACIO VALLEY ROAD, WALNUT CREEK, CA, 94598, US

(21) Appl. No.: 11/288,181

(22) Filed: Nov. 29, 2005

(51) Int. Cl. C03B 19/09; C03C 3/06

(52) U.S. Cl. 501/54; 65/17.3

(57) ABSTRACT

A current stabilizing device is provided herein, which mainly contains a closed enclosure and at least a quartz ball. The enclosure has at least a spherical chamber for accommodating the quartz ball. Along the inner wall of the spherical chamber, there is a protruding rib whose inner diameter is smaller than that of the quartz ball and circling the inner wall of the spherical chamber. When the quartz ball is housed inside the spherical chamber, the rib exerts pressure on the surface of the quartz ball. When the enclosure is tied to a cable constituting a part of the circuit whose electrical current is to be regulated, the quartz ball generates an oscillating electromagnetic field along the cable which could stabilize or regulate the electrical current and remove the impulses and noises occurred in the circuit.

### BACKGROUND OF THE INVENTION

(a) Technical Field of the Invention

The present invention generally relates to electrical current stabilizing devices, and more particularly to a device utilizing quartz balls to stabilize the electrical current in a circuit.

(b) Description of the Prior Art

The proper function and reliability of electronic devices depend largely on the stability of the electrical current supplied to these devices. For motor vehicles such as automobiles and motorcycles, due to the traffic condition, the voltage provided by the alternator is constantly changing, causing unstable electrical current in the vehicle's electrical system. The most direct impact is on the operation of the car computer, leading to malfunctions such as inaccurate air/fuel mixture and spark timing, and causing problems such as inferior fuel economy.

To solve the problem, there are so-called “reverse current” removal device commercially available in the market for absorbing the irregular current occurred in the circuit of an automobile's electrical system. However, almost all such products rely on the use of electrolytic capacitors and these capacitors, despite of their low cost, deteriorate quickly under the harsh operating conditions of the engine room such as the high temperature, humidity, and severe vibrations. These devices therefore quickly lose their functionality after a period of usage.

### SUMMARY OF THE INVENTION

The primary purpose of the present invention is to provide a device utilizing quartz balls to regulate the electrical current, which is both easy to install and highly resilient to various environment conditions.

The present invention mainly contains a closed enclosure and at least a quartz ball. The enclosure has at least a spherical chamber for accommodating the quartz ball. Along the inner wall of the spherical chamber, there is a protruding rib circling the inner wall of the spherical chamber, whose diameter is smaller than that of the quartz ball. When the quartz ball is housed inside the spherical chamber, the protruding rib exerts pressure on the surface of the quartz ball. In an embodiment of the present invention, the enclosure has two spherical chambers and, when two quartz balls are housed, they are tightly compressed against each other. To use the present invention, the enclosure is directly tied to a cable constituting a part of the circuit whose electrical current is to be regulated. The configuration of the rib should be such that the axial direction of the rib is aligned with the cable.

In an alternative embodiment, a first quartz ball is directly tied to a cable constituting a part of the circuit whose electrical current is to be regulated. Then a second quartz ball is arranged to press tightly against the first quartz ball along the cable and, then, a scotch tape is used to fixedly join the two quartz balls together.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective blown-up view showing the current stabilizing device according to a first embodiment of the present invention.

FIG. 2 is a sectional view showing the interior of the current stabilizing device of FIG. 1.

FIG. 3 is a schematic view showing the current stabilizing device of FIG. 1 is used along with a battery of the electrical system of an automobile.

FIG. 4 is a section view showing the interior of the current stabilizing device according to a second embodiment of the present invention.

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

Quartz, or quartz crystal, is adopted in the present invention due to its piezoelectric property. When compressed or bent, quartz generates a change of voltage on its surface, a phenomenon called the piezoelectric effect. In the same way, if a voltage is applied, quartz will bend or change its shape very slightly. Combining these two factors together, if quartz is under both a structural pressure and an electromagnetic field, it will generate an oscillating electromagnetic field which could be utilized to regulate the electrical current in a circuit. Another desirable characteristic of quartz is that it is unaffected by most solvents and remains crystalline to hundreds of degrees Fahrenheit.

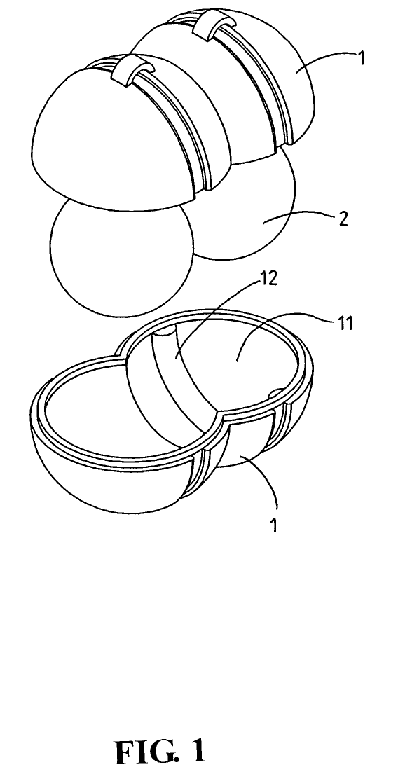

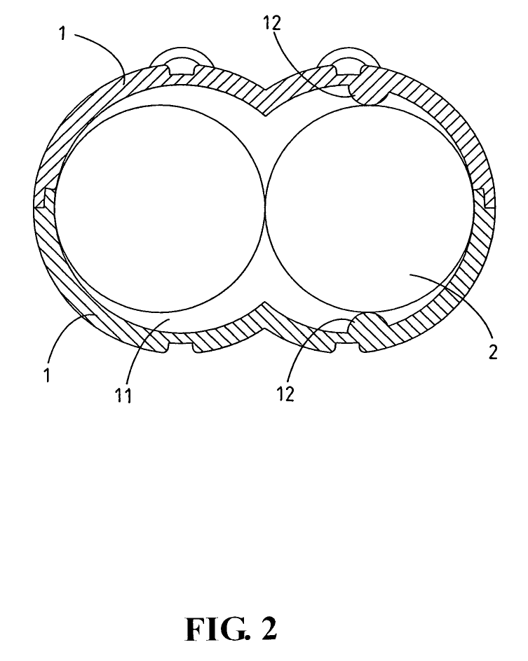

As illustrated in FIGS. 1 and 2, a first embodiment of the present invention contains a closed enclosure 1 and two quartz balls 2. The enclosure 1 forms two hollow spherical chambers 11 for the accommodation of the two quartz balls 2. The enclosure 1 is configured such that, when the two quartz balls 2 are housed in the spherical chambers 11, they are linearly aligned and tightly compressed against each other. Inside one of the spherical chambers 11, a protruding rib 12 is configured to circle around the inner wall of the chamber 11 so as to form a ring whose axial direction coincides with the linear alignment of the quartz balls 2. The ring formed by the protruding rib 12 has an inner diameter smaller than the diameter of the quart ball 2.

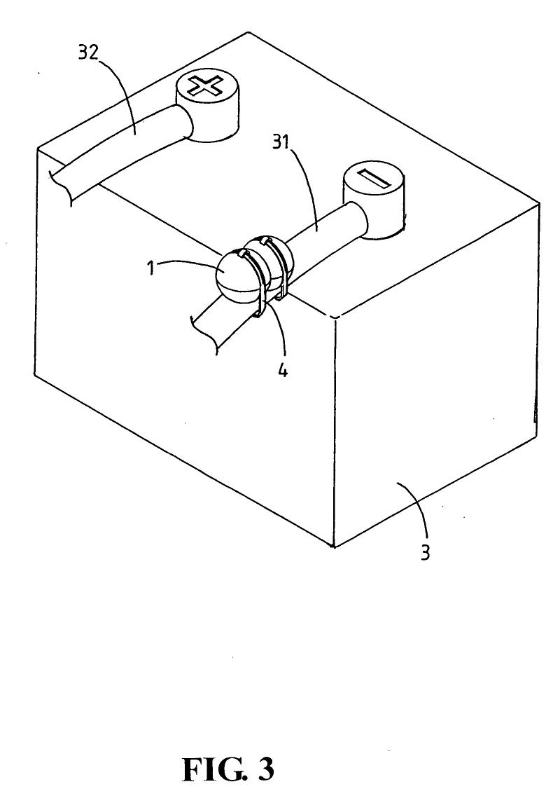

To use the present embodiment, as illustrated in FIG. 3, the enclosure 1 is fixedly attached using cable ties 4 to the cable 31 connected to the negative terminal of an automobile's battery 3. Another cable 32 is connected to the positive terminal of the battery 3. Please note that the linear alignment of the quartz balls 2 (i.e., along the axial direction of the rib 12) coincides with the extension of the cable 31. As such, the quartz balls 2 are both under the structural pressure from the rib 12 and under the influence of the electromagnetic field generated by the electrical current flowing through the cable 31. Due to the piezoelectric property of the quartz balls 2, they will in turn generate an oscillating electromagnetic field along the axial direction of the rib 12 (i.e., along the cable 31 which could stabilize or regulate the electrical current flowing through the cable 31. The present invention could also remove the impulses and noises occurred in the circuit.

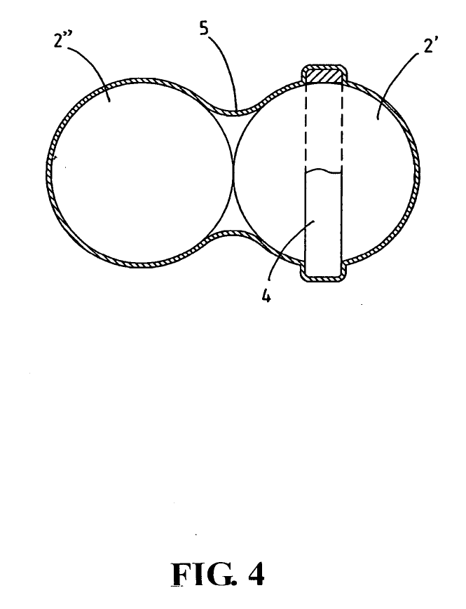

Based on the same quartz ball alignment, the present invention could be applied without the enclosure 1 as shown in FIG. 4. In this second embodiment, a first quartz ball 2′ is directly tied to a cable (not shown) using a cable tie 4. If the cable tie 4 is too long, the extraneous section should be cut and removed. Then, a second quartz ball 2″ is positioned tightly against the first quartz ball 2′ along the axial direction of the cable tie 4 (i.e., along the cable). Then a scotch tape 5 is used to fixedly join the two quartz balls 2′ and 2″ tightly together.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A current stabilizing device, comprising:
at least a quartz ball; and
a closed enclosure comprising at least a spherical chamber, said spherical chamber comprising a protruding rib circling along the inner wall of said spherical chamber, said protruding rib having an inner diameter smaller than that of said quartz ball;
wherein, when said quartz ball is housed inside said spherical chamber, said rib exerts pressure on the surface of said quartz ball.

2. The current stabilizing device according to claim 1, wherein said enclosure comprises two spherical chambers for housing two quartz balls.

3. The current stabilizing device according to claim 2, wherein said two spherical chambers are configured such that said two quartz balls are tightly compressed against each other.

4. The current stabilizing device according to claim 2, wherein said two spherical chambers are configured such that they are linearly aligned along the axial direction of said protruding rib.

5. A current stabilizing device, comprising:
a first quartz ball; and
a second quartz ball;
wherein said first quartz ball is tied to a cable of a circuit using a cable tie; said second quartz ball is positioned tightly against said first quartz ball and along the axial direction of said cable tie; and said first and second quartz balls are fixedly joined together by a scotch tape.
